(19) United States
(12) Patent Application Publication
(10) Pub. No.: US 2014/0185753 A1
(43) Pub. Date: Jul. 3, 2014

(54) VEHICLE-MOUNTED CARGO INSPECTION SYSTEM

(71) Applicants: Sarfraz Azmi, Belmont, MA (US); Jasper Bogosian, JR., Needham, MA (US); John J. Reilly, Waltham, MA (US); Randy Barnby, Boston, MA (US)

(72) Inventors: Sarfraz Azmi, Belmont, MA (US); Jasper Bogosian, JR., Needham, MA (US); John J. Reilly, Waltham, MA (US); Randy Barnby, Boston, MA (US)

(73) Assignee: L-3 Communications Security and Detection Systems, Inc., Woburn, MA (US)

(21) Appl. No.: 13/538,241

(22) Filed: Jun. 29, 2012

Related U.S. Application Data
(60) Provisional application No. 61/502,612, filed on Jun. 29, 2011.

(51) Int. Cl. G01V 5/00

(52) U.S. Cl. CPC G01V 5/005
USPC 378/57

(57) ABSTRACT

Some embodiments of the invention provide a mobile cargo inspection system mounted on a vehicle chassis type which does not include rails that extend from near the front of the vehicle to near the back. As such, detection components may be placed between the front and rear axles of the vehicle without penetrating radiation having to pass through a chassis rail before reaching the cargo to be inspected. As a result, the weight of the vehicle-mounted cargo inspection system may be more evenly distributed from the front of the vehicle to the back, and from one side of the vehicle to the other, thus making the system easier to operate, safer, and less costly to maintain than conventional systems.

### RELATED APPLICATION

This application claims the benefit under 35 U.S.C. §119(e) of the filing date of U.S. Provisional Application Ser. No. 61/502,612, filed Jun. 29, 2011, bearing Attorney Docket No. L0632.70112US00, entitled “COACH/BUS X-RAY CARGO VEHICLE SCANNER,” the entirety of which is incorporated herein by reference.

### BACKGROUND

Numerous cargo containers pass through shipping terminals and other access points every day. Weapons, explosives and/or other contraband may be concealed within any one of the cargo containers. Because it is difficult to open every container and inspect its contents, inspection systems are conventionally used to detect contraband within cargo containers. Frequently, inspection systems employ penetrating radiation (e.g., x-rays) to form an image of items in a container under inspection. Specifically, by measuring the radiation after it has interacted with items in a container, an image of the items may be formed.

Cargo containers are large, and are inspected by vehicle-mounted or gantry based inspection systems. A vehicle-mounted inspection system may, for example, include an x-ray source and a boom with a detector array at the end. When a vehicle-mounted inspection system is positioned next to a cargo container, the boom extends over the cargo container to position the detector array so that radiation from the x-ray source is detected after passing through the cargo container. To generate an image for inspection, a vehicle-mounted inspection system may be moved relative to the cargo container during scanning. For example, an image may be formed of different pieces of the cargo container as the vehicle-mounted inspection system moves relative to the cargo container, and the image pieces may then be assembled into a composite image of the cargo container that may be analyzed to detect contraband stored in the container.

### SUMMARY

The inventors have appreciated that the overall weight of conventional vehicle- mounted inspection systems limits the type of vehicle chassis upon which the inspection system may be mounted. In this respect, conventional vehicle-mounted inspection systems typically weigh approximately thirty to thirty-five metric tons. As a result, conventional vehicle-mounted inspection systems are generally truck-mounted, since a truck chassis can support the total weight of conventional systems, but other conventional chassis types cannot. A truck chassis includes chassis rails, usually extending from near the front of the truck to near the back of the truck, which bear the weight of the truck's body and its contents. The chassis rails are usually situated above the height of the truck's front and rear axles to accommodate a drive shaft which extends from the engine in the front of the truck to the rear axle. The inventors have recognized that use of a truck chassis imposes unnecessary constraints, owing mainly to the chassis rails located between the front and rear axles to accommodate the drive shaft.

For example, in one type of conventional truck-mounted inspection system, the x-ray source, boom and detector array are located between the front and rear axles, all on one side of the truck-mounted system (e.g., on the passenger side). The x-ray source and detector array are placed on the same side of the truck so that a beam emitted by the x-ray source need not cross (i.e., pass through) a chassis rail on the way to the detector, since having a beam cross a chassis rail can detract from the system's ability to thoroughly and accurately scan a container's contents. However, placement of the x-ray source and detector on one side of the truck creates an uneven weight distribution from one side of the truck to the other. As a result, a counter weight is commonly extended from the side of the vehicle that is opposite the x-ray source and detector while scanning is performed. The total weight of the detection components and counter weight can put the system at risk of exceeding road weight limits, as the x-ray source and detector conventionally weigh about seven metric tons in total, and the counter weight typically weighs about three metric tons. In addition, the counter weight does not eliminate the uneven weight distribution from one side of the vehicle to the other, so this type of system is difficult to operate. For example, the truck may veer to one side while being driven between scanning locations, which not only can detract from operator safety but can also increase the cost of maintaining the system. Moreover, images produced by this type of system often have a perspective which make them difficult to inspect.

In another type of conventional truck-mounted inspection system, the chassis rails behind the rear axle of the truck are removed, and the x-ray source, boom and detector array are placed behind the rear axle, so that a beam emitted by the x-ray source need not pass through a chassis rail on the way to a cargo container and the detector array. However, even though the x-ray source and detector array may be located on opposite sides of the truck (e.g., the x-ray source may be located on the driver's side of the truck, and the detector array may be located outside the truck's body on the passenger side), the weight of this type of system may still be somewhat unevenly distributed from one side of the truck to the other, and is very unevenly distributed from the front of the truck to the back, making the vehicle difficult to operate. In some conventional systems, a ballast may be used near the front of the truck to counteract the weight of the detection components in the back. However, the additional weight of the ballast may sometimes cause the overall system to exceed certain road weight limits.

The inventors have recognized that these and other deficiencies of conventional systems may be overcome by reducing the overall weight of the system. Specifically, the inventors recognized that by reducing the overall weight of the system so that it could be mounted on a chassis type which does not include rails extending from near the front of the vehicle to near the back (e.g., to a total weight of less than twenty-three metric tons), the detection components could be placed between the front and rear axles without an x-ray beam having to pass through a chassis rail, thus more evenly distributing the weight of the system from the front of the vehicle to the back. In addition, the inventors recognized that reducing the overall system weight may mitigate to some extent any uneven weight distribution from one side of the vehicle to the other. As a result, a system which is much easier to operate, safer, and less costly to maintain than conventional systems may be produced.

In some embodiments of the invention, a mobile cargo inspection system is mounted to a coach or bus chassis, which may include a plurality of distinct chassis segments, each assembled from a plurality of struts and/or other structural members. A “mid-vehicle” segment may be situated between the front and the rear wheels, and may be configured to accommodate one or more detection components, such as the radiation source and/or other components.

In some embodiments, the absence of chassis rails extending from near the front of the vehicle to near the back of the vehicle above axle height may mean that an x-ray source may be placed on the opposite side of the vehicle from a detector array, without beams emitted by the x-ray source being obstructed by the chassis rails during operation. Thus, image quality need not be sacrificed to achieve the safety, ease of operation and reduced maintenance costs associated with an approximately even distribution of weight from the front of the vehicle to the back of the vehicle, and from one side of the vehicle to the other side of the vehicle.

The foregoing is a non-limiting summary of the invention, some embodiments of which are defined by the attached claims.

### BRIEF DESCRIPTION OF DRAWINGS

The accompanying drawings are not intended to be drawn to scale. In the drawings, each identical or nearly identical component as illustrated in various figures is represented by a like numeral. For purposes of clarity, not every component may be labeled in every drawing. In the drawings:

FIG. 1 is a perspective view of a vehicle-mounted cargo inspection system having shielding components, in accordance with some embodiments of the invention;

FIG. 2A is a front, driver-side perspective view of components of a vehicle-mounted inspection system implemented in accordance with some embodiments of the invention;

FIG. 2B is a rear, passenger-side perspective view of components of a vehicle-mounted inspection system implemented in accordance with some embodiments of the invention;

FIG. 2C is a top perspective view of components of a vehicle-mounted inspection system implemented in accordance with some embodiments of the invention; and

FIG. 3 is a rear perspective view of a vehicle-mounted inspection system implemented in accordance with some embodiments of the invention.

### DETAILED DESCRIPTION

The inventors have recognized that various deficiencies of conventional vehicle-mounted inspection systems may be overcome by reducing the overall weight of the system so that it may be mounted on a vehicle chassis type which does not include rails that extend from near the front of the vehicle to near the back. As such, detection components may be placed between the front and rear axles of the vehicle, without an x-ray beam having to pass through a chassis rail, and the weight of the system may be more evenly distributed from the front of the vehicle to the back of the vehicle, making the system easier to operate, safer, and less costly to maintain than conventional systems.

Embodiments of the invention may employ any of numerous techniques to reduce overall system weight to enable use of a chassis type that does not include chassis rails extending from roughly the front of the vehicle to the back of the vehicle. For example, in some embodiments, overall system weight may be reduced by eliminating or reducing of the use of heavier materials in system components. As one example, some embodiments of the invention may reduce overall system weight by removing excess lead from shielding components which shield operators from radiation emitted during system operation. Removing excess lead from shielding components may be performed in any of numerous ways. In some embodiments, an analysis may be undertaken to determine the amount of radiation expected in various locations within the vehicle and in the vehicle's vicinity while radiation is being emitted from a radiation source, determine how much lead is needed to limit expected radiation levels at various locations, and remove any lead which is not needed to limit radiation. As a result, embodiments of the invention may reduce overall system weight without compromising operator safety.

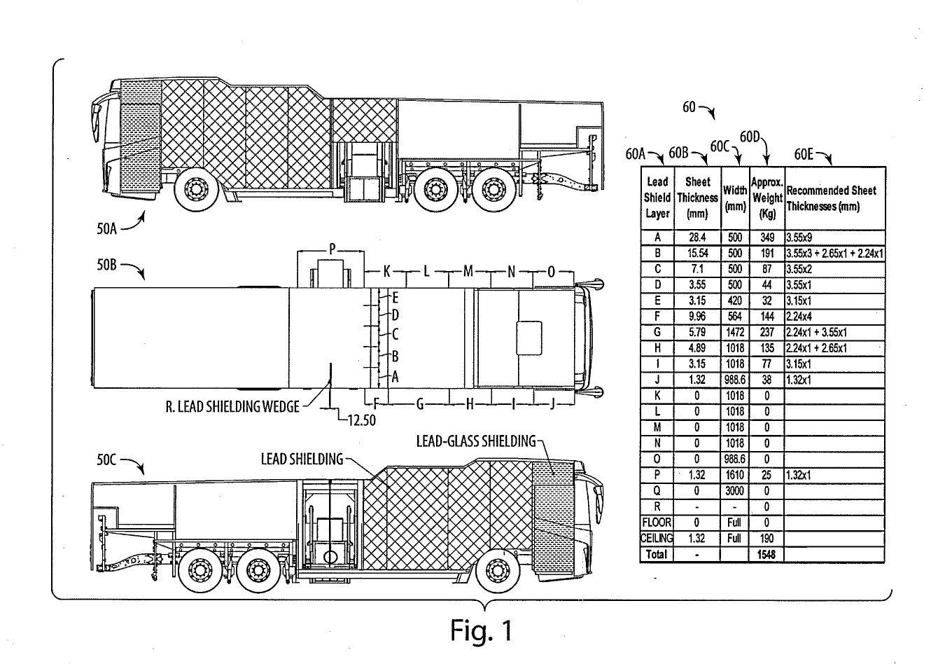

Some example lead thicknesses which may lead to a reduction in weight relative to conventional shielding components without compromising operator safety are shown in FIG. 1. In particular, FIG. 1 depicts a perspective view of an inspection system mounted on a bus chassis, including driver's side view 50A, top view 50B, and passenger's side view 50C. Table 60 provides example lead sheet thicknesses used in shielding panels which are listed in column 60A and shown in top view 50B, as well as the width of the panel (shown in column 60C), the approximate weight (shown in column 60D) and how the sheet thickness in column 60B may be achieved (shown in column 60E). For example, table 60 indicates that the shielding panel labeled “A” in top view 50B has a thickness of 28.4 mm (as shown in column 60B), a width of 500 mm (as shown in column 60C), an approximate weight of 349 kg, and that the thickness of 28.4 mm shown in column 60B may be achieved through the use of nine panels of thickness 3.55 mm each (“3.55×9”). Similarly, table 60 indicates that the shielding panel labeled “B” in top view 50B has a thickness of 15.54 mm (as shown in column 60B), a width of 500 mm (as shown in column 60C), an approximate weight of 191 kg, and that the thickness of 15.54 mm shown in column 60B may be achieved through the use of three panels of thickness 3.55 mm, one panel of thickness 2.65 mm and one panel of thickness 2.24 mm (“3.55×3+2.65×1+2.24×1”). Example thicknesses of other shielding panels labeled C through P in top view 50B are also shown in table 60. It should be apparent that, in the arrangement shown, shielding components are configured such that the thickest lead panels are located in the partition between the front and back of the vehicle (i.e., in the shielding panels labeled “A” through “E”), and the thickest panels used on the exterior of the vehicle are those located on the passenger side, closest to the detector (i.e., shielding panels “F” through “J”). Of course, the arrangement of panels shown in FIG. 1 represents merely one example, as any of numerous other arrangements may alternatively be employed. Overall, by reducing the use of lead in shielding components, embodiments of the invention may reduce overall system weight without compromising operator safety, so that the system may be mounted on a chassis type which does not include chassis rails extending from roughly the front of the vehicle to the back of the vehicle.

Removing excess lead from shielding components represents only one possible approach to reducing overall system weight relative to conventional systems. In some embodiments of the invention, overall system weight may also, or alternatively, be reduced by using components made of more lightweight materials than those which are used in corresponding components in conventional systems. For example, in some embodiments of the invention, vehicle body panels may be made of fiberglass and/or other lightweight (e.g., composite) materials, rather than aluminum and/or steel as in conventional systems. As another example, portions of the vehicle chassis may be made from fiberglass and/or other lightweight (e.g., composite) materials, rather than the steel from which a chassis may be constructed in conventional systems.

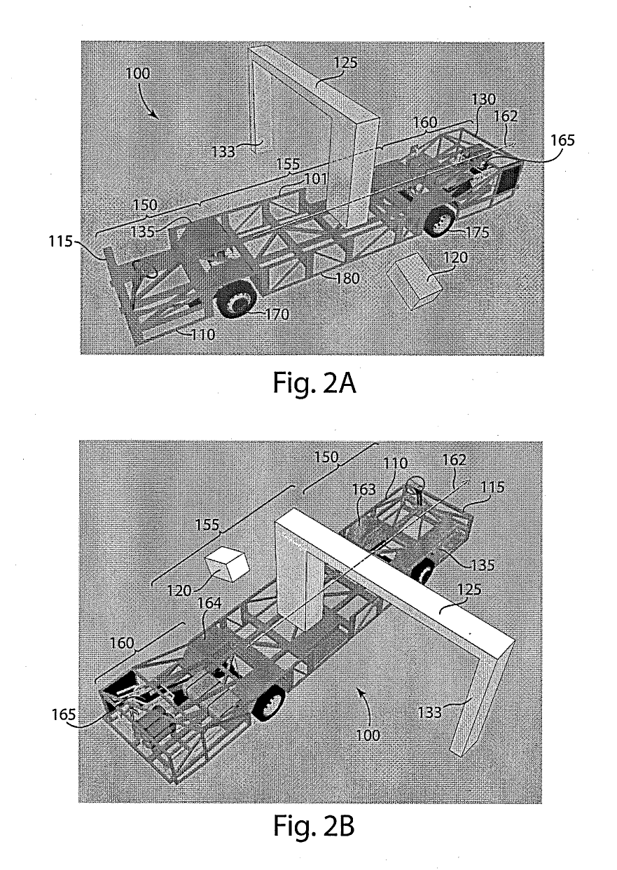

An example mobile cargo inspection system which is lightweight enough to mount on a chassis that does not include chassis rails running from near the front of the vehicle to near the back of the vehicle is shown in FIGS. 2A-2C. Specifically, FIG. 2A provides a front, driver-side perspective view of example components of system 100, FIG. 2B provides a rear, passenger-side perspective view of example components of system 100, and FIG. 2C provides a top perspective view of example components of system 100. System 100 includes a chassis 101, which includes front 115 and rear 130. System 100 also includes detection components used to determine the presence of contraband in cargo containers, including x-ray source 120, boom 125 and detector array 133. In the embodiments shown, x-ray source 120 and detector array 133 are disposed on opposite sides of vehicle midline 162, which extends approximately parallel to driver side 110 and passenger side 135, perpendicular to front axle 163 and rear axle 164, between front 115 and rear 130. Vehicle midline 162 may, for example, pass through a center of mass of system 100, or extend between front 115 to rear 130 through any other suitable portion(s) of system 100.

It should be appreciated that although an x-ray source is shown in FIGS. 2A- 2C, embodiments of the invention are not limited to using x-rays as a form of penetrating radiation, or even to using penetrating radiation at all, as any suitable detection techniques and/or apparatus may be employed.

In the perspective views of FIGS. 2A-2C, x-ray source 120 is shown as being physically separate from chassis 101. It should be understood that this depiction is for ease of illustration, and that in many embodiments of the invention, x-ray source 120 will be physically coupled in some manner to the body of the vehicle (e.g., to chassis 101). For example, in some embodiments, x-ray source 120 may be disposed in a drawer-like mechanism (not shown in FIGS. 2A-2C) which slides in and out of a cavity in chassis 101 (e.g., on driver's side 110). Of course, any of numerous alternatives to a drawer-like mechanism may be employed.

If system 100 allows x-ray source 120 to be moved away from the body of the vehicle (e.g., using a drawer-like mechanism, and/or some other assembly), its weight may counter-balance the weight of boom 125 and detector array 133, which in the example arrangement shown extends away from passenger side 135 of chassis 101. As a result, the detection components may be placed such that overall system weight is distributed approximately evenly from one side of the vehicle (e.g., driver's side 110) to the other side of the vehicle (e.g., passenger side 135). As a result, the vehicle may be less likely to veer to one side or the other when operated.

As can be seen from FIGS. 2A-2C, chassis 101 does not include chassis rails that extend from near the front of the vehicle to near the back above the axle height. Rather, in the example implementation shown, chassis 101 includes three distinct segments, including front segment 150, middle segment 155 and rear segment 160, each comprising a plurality of struts that may be welded or otherwise joined in any suitable fashion. Of course, embodiments of the invention need not include three distinct segments (any suitable number may be employed), each segment may comprise any suitable type(s) of structural member, and any suitable manner of construction may be employed. Embodiments of the invention are not limited to being implemented in any particular manner.

In the example arrangement shown in FIGS. 2A-2C, front segment 150 supports the section of the vehicle extending roughly from the front wheels 170 to vehicle front 115, including the driver's cab. Middle segment 155 supports the section of the vehicle extending roughly between the front wheels 170 and rear wheels 175. Rear segment 160 supports the section of the vehicle extending roughly from the rear wheels 175 to vehicle rear 130, including engine 165 at the back of the vehicle. Of course, other embodiments of the invention may distribute the weight of the system differently than in the example manner shown in FIGS. 2A-2C.

In the example shown in FIGS. 2A-2C, the weight of x-ray source 120, boom 125 and detector array 133 is largely borne by middle segment 155, approximately halfway between front wheels 170 and rear wheels 175. Thus, the weight of system 100 is distributed approximately evenly from the front of the vehicle to the back of the vehicle. As a result, a ballast need not be employed to counterbalance the weight of the detection components.

It can be seen from FIGS. 2A-2C that middle segment 155 of chassis 101 includes members which are closer to the ground than the front or rear axles. For example, member 180 is closer to the ground than either the front axle or the rear axle. As a result of this, x-ray source 120 may also be situated closer to the ground than if it sat atop chassis rails situated above axle height. In this respect, the inventors have appreciated the desirability of being able to scan a cargo container close to, if not at, ground level. In a conventional arrangement with a chassis having rails above axle height, to distribute the overall weight of the system approximately evenly from front to back and from side to side, the x-ray source would have to sit atop the chassis rails near the center of the vehicle. Even if so situated, radiation emitted by the x-ray source may be obstructed somewhat by the chassis rails before reaching the cargo container. With the x-ray source sitting atop axle height, it can be difficult to scan contents of a cargo container that are close to the ground. By contrast, embodiments of the invention, by situating the x-ray source below axle level, enable scanning of cargo container contents which are close to the ground, without sacrificing roughly even weight distribution and thus system operability.

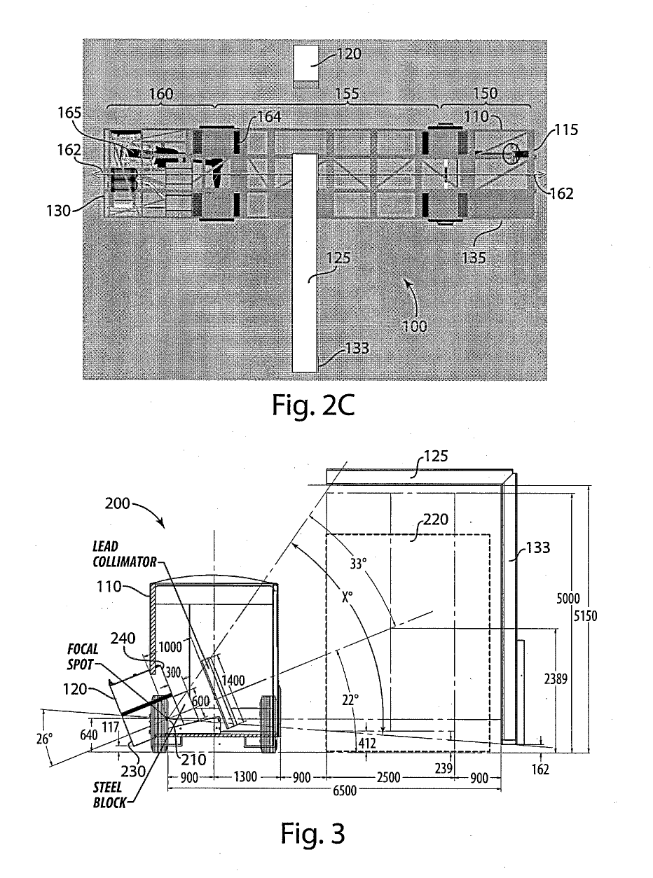

FIG. 3 shows this feature in greater detail. FIG. 3 provides a rear perspective view of an example vehicle-mounted inspection system 200, implemented in accordance with some embodiments of the invention. It should be appreciated that while FIG. 3 shows boom 125 being detached from vehicle 230, this representation is used merely for ease of illustration, and that boom 125 may in many arrangements be physically coupled to the vehicle rather than detached as shown in the figure.

In the example arrangement of FIG. 3, x-ray source 120 is a linear accelerator having a focal spot 210, oriented to emit radiation toward cargo container 220. Cargo container 220 may, for example, be a vehicle, box, crate, and/or some other cargo container(s). Because x-ray source 120 does not sit atop chassis rails above axle height, x-ray source 120 may be oriented so as to emit radiation over a range encompassing nearly the entirety of cargo container 220. In this respect, in the example arrangement shown, radiation is emitted from focal spot 210 over a range of X degrees. By dropping the side 230 of x-ray source 120 furthest from detector array 133 with respect to the opposite side 240, as shown in FIG. 2, that range can be made to encompass most if not all of cargo container 220, including portions which are closest to the ground, such as those below axle level if cargo container 220 comprises a vehicle. Of course, the side 230 of x-ray source 120 furthest from detector array 133 need not be dropped with respect to the opposite side 240 for the range over which radiation is emitted to encompass contents in the bottom of cargo container 220. For example, side 240 could be lowered with respect to side 230, or any other suitable technique could be employed. Embodiments of the invention are not limited in this respect.

In the example arrangement shown in FIG. 3, because the range over which radiation is emitted by x-ray source 120 encompasses nearly all of cargo container 220, detector array 133 may measure the radiation after it has passed through cargo container 220, enabling an image of most if not all of the contents of cargo container 220 to be formed.

During operation, mobile inspection system 200 may be moved with respect to cargo container 220 to detect contraband within cargo container 220. For example, images may be formed of multiple segments of cargo container 220 as vehicle-mounted inspection system 200 moves relative to it, and the images may then be assembled into a composite image of the contents of cargo container 220. Given the relatively even distribution of the weight of vehicle-mounted inspection system 200 from one side to another, and from front to back, vehicle-mounted inspection system 200 may be easier to operate than conventional systems while an inspection is being performed. Further, the even distribution of weight may enable vehicle-mounted inspection system 200 to be driven more easily from one inspection site to another. For example, the relatively even weight distribution afforded by embodiments of the invention may enable the system to be driven from a site at which a first inspection occurs to one at which a second inspection occurs, without experiencing the veering to one side which commonly occurs in conventional systems. As a result, embodiments of the invention may provide a system which is not only safer and easier to operate, but also less costly to maintain over time.

Having thus described several aspects of at least one embodiment of this invention, it is to be appreciated that various alterations, modifications, and improvements will readily occur to those skilled in the art.

Such alterations, modifications, and improvements are intended to be part of this disclosure, and are intended to be within the spirit and scope of the invention. Further, though advantages of the present invention are indicated, it should be appreciated that not every embodiment of the invention will include every described advantage. Some embodiments may not implement any features described as advantageous herein and in some instances. Accordingly, the foregoing description and drawings are by way of example only.

Various aspects of the present invention may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

What is claimed is:

1. A vehicle-mounted cargo inspection system, comprising:
a vehicle having a front, a rear, a first side, a second side, at least one front wheel axle located proximate the front of the vehicle, at least one rear wheel axle located proximate the rear of the vehicle, and a vehicle midline, approximately perpendicular to the at least one front wheel axle and the at least one rear wheel axle, extending from the front to the rear of the vehicle between the first side and the second side; and
detection components coupled to the vehicle, the detection components comprising a radiation source operable to emit penetrating radiation, and a detector operable to detect and measure radiation emitted by the radiation source;
wherein the radiation source is located between the at least one front axle and the at least one rear axle, and wherein the radiation source and the detector are located on opposite sides of the vehicle midline.

2. The vehicle-mounted cargo inspection system of claim 1, wherein the vehicle comprises a chassis that does not include chassis rails to accommodate a drive shaft extending between the front and rear axles.

3. The vehicle-mounted cargo inspection system of claim 2, wherein the chassis is a bus or coach chassis.

4. The vehicle-mounted cargo inspection system of claim 2, wherein the chassis is composed at least partially of a lightweight composite material.

5. The vehicle-mounted inspection system of claim 2, wherein the chassis comprises a plurality of chassis segments, at least one of the plurality of segments comprising a cavity to accommodate the radiation source.

6. The vehicle-mounted inspection system of claim 5, wherein the radiation source slides into the cavity using a drawer-like mechanism.

7. The vehicle-mounted cargo inspection system of claim 1, wherein the vehicle comprises body panels composed at least partially of lightweight composite material.

8. The vehicle-mounted cargo inspection system of claim 1, comprising at least one shielding component operable to shield an operator from radiation emitted from the radiation source, the at least one shielding component comprising lead in an amount so as to limit radiation emitted from the radiation source, but not to contribute excess weight to the vehicle-mounted cargo inspection system.

9. The vehicle-mounted cargo inspection system of claim 8, wherein:
the vehicle comprises a compartment proximate the front of the vehicle for use by an operator,
the at least one shielding component comprises a plurality of shielding panels each comprising at least one lead panel, each at least one lead panel having a thickness;
the plurality of shielding panels comprises at least one shielding panel on the exterior of the vehicle on the first side, at least one shielding panel on the exterior of the vehicle on the second side, and at least one shielding panel in a partition between the front compartment and the rear of the vehicle; and
the thickness of the at least one lead panel in the at least one shielding panel in the partition is greater than the thickness of the at least one lead panel in the at least one shielding panel on the exterior of the vehicle on the first side.

10. The vehicle-mounted cargo inspection system of claim 9, wherein the thickness of the at least one lead panel in the at least one shielding panel on the exterior of the vehicle on the second side is greater than the thickness of the at least one lead panel in the at least one shielding panel on the exterior of the vehicle on the first side.

11. The vehicle-mounted cargo inspection system of claim 1, wherein the system has a total weight of less than twenty-three metric tons.

12. The vehicle-mounted cargo inspection system of claim 1, wherein the system has a center of mass located approximately halfway between the driver side and the passenger side.

13. The vehicle-mounted cargo inspection system of claim 1, wherein the system has a center of mass, and wherein the vehicle midline extends proximate the center of mass.

14. The vehicle-mounted cargo inspection system of claim 1, wherein the vehicle midline extends from the front to the rear of the vehicle approximately halfway between the first side and the second side.

15. The vehicle-mounted cargo inspection system of claim 1, wherein the at least one front axle and the at least one rear axle are disposed at a height, and wherein the radiation source is located below the height.

16. The vehicle-mounted cargo inspection system of claim 1, wherein the first side is a driver side of the vehicle and the second side is a passenger side of the vehicle.
